(19) United States
(12) Patent Application Publication
(10) Pub. No.: US 2011/0150959 A1
(43) Pub. Date: Jun. 23, 2011

(54) WIPE WITH ODOUR CONTROL SUBSTANCE

(75) Inventors: Bo Andreasson, Sundsvall (SE); Ulla Forsgren Brusk, Pixbo (SE); Kent Malmgren, Sundsvall (SE); Chatrine Stridfeldt, Hovas (SE)

(73) Assignee: SCA Hygiene Products AB, Goeteborg (SE)

(21) Appl. No.: 13/062,137

(22) PCT Filed: Oct. 3, 2008
(86) PCT No.: PCT/SE2008/000546

§ 371 Date: Mar. 3, 2011

(30) Foreign Application Priority Data
Aug. 21, 2008 (DE) 10 2008 039 007.0

(51) Int. Cl. A01N 25/08; A01N 37/00; A01P 1/00

(52) U.S. Cl. 424/409; 514/558

(57) ABSTRACT

A wipe, in particular a personal hygiene wipe such as a baby care, feminine hygiene care, incontinence care, hand care or foot care wipe, includes a composition including oxidized lipids as an odour control substance. The lipids are oxidized under controlled conditions to have a peroxide value of at least 20 meq/kg. The lipids are for example triglycerides of fatty acids.

### TECHNICAL FIELD

The present invention refers to a wipe comprising a carrier material to which has been added a composition adapted to fulfil one or more of the following purposes: cleaning, skin care, odour control, antibacterial effect or the like.

### BACKGROUND OF THE INVENTION

Odour control has become an important factor in personal hygiene, especially in the urogenital area of persons wearing absorbent articles like incontinence guards, sanitary napkins, diapers and the like. Odours or unpleasant smells occur e.g. as a result of accumulation of bacteria. These odours can be embarrassing for the user of absorbent articles. It is important, therefore, to reduce or prevent odours from occurring in absorbent articles, but also be able to clean the urogenital area from odour substances and/or to prevent odour to occur.

Examples of odour substances that may occur in the urogenital area of persons wearing absorbent articles are sulphur compounds, aldehydes, indoles, amines etc.

Various methods are used to prevent or reduce such odours to occur in absorbent articles. The methods are based on 1) masking of the odours; 2) a chemical reaction, for example in the form of neutralization, with an acid/base system; 3) adsorption/absorption of odour substances involving the creation of surfaces which exhibit a special affinity to the odour substances or large specific surfaces/cavities which are able to bind the odour substances concerned and thus to prevent them from remaining in gaseous form, or 4) bacteria inhibitors which reduce/control the growth of bacteria and associated odour substances that have arisen because of high bacteria counts.

Perfumes or fragrances are used, for example, in order to mask odours/smells. Maskers do not remove the smells and must be added in an appropriate quantity to ensure that the smell does not penetrate or that the perfume does not smell too strongly. Zeolites, silicone dioxide, clays, active carbon and/or cyclodextrin, for example, are used for the adsorption of odour substances. Some of these are susceptible to moisture, however, which restricts their effectiveness. Sodium bicarbonate, citric acid and/or superabsorbent materials with a low pH are used for the neutralization of odours. Bacteria can generate substances with an unpleasant smell, and copper acetate, a superabsorbent material with silver ions and/or an acidic superabsorbent material can be used to reduce the growth of bacteria. The above-mentioned odour control substances are effective against different kinds of odours and act with different mechanisms.

A number of odourants are hydrophobic, and such smells are absorbed and/or adsorbed by hydrophobic odour control substances. Hydrophobic odoriferous substances include, for example, certain organic acids, sulphur compounds, aldehydes, indole, certain amines, etc., which commonly occur in conjunction with the use of absorbent articles.

Previously disclosed odour control substances suffer from the disadvantage, among other things, that they are difficult to distribute uniformly throughout the whole of a carrier material, for example a fibrous web. This is attributable to the fact that previously disclosed odour control materials often consist of solid particles, which cannot be distributed continuously over the internal and external surfaces of the product and as such reduce the degree of coverage. The possibility of trapping undesirable odours in an effective manner is reduced in this way.

U.S. Pat. No. 6,479,150 describes material layers of thermoplastic fibers with a hydrophobic odour control substance that is modified with a surface-active substance in order to make the layer wettable. The odour control substance is, for example, an aromatic odour control substance.

GB 1 282 889 discloses a deodorant composition comprising at least one calcium, aluminum, magnesium or zinc salt of an unsaturated aliphatic hydroxycarboxylic acid having at least 17 carbons. It is further told that these metal salts can be combined with saturated aliphatic hydroxycarboxylic acids and unsaturated aliphatic hydroxycarboxylic acids. The saturated hydroxycarboxylic acids may either be naturally saturated or derived from oxidation products of unsaturated fatty acids, such as oleic acid, ricinoleic acid, linoleic acid and linolenic acid. These unsaturated fatty acids upon mild oxidation lead to corresponding pure hydroxycarboxylic acids. Pure hydroxycarboxylic acids have very low oxidizing ability on other substances and a peroxide value close to 0 meq/kg.

Bacteria control is another important factor in personal hygiene, both in the urogenital area but also in hand hygiene. Keeping a good hand hygiene for avoiding the spreading of bacteria is especially important in restaurants, in kitchens, in medical care premises, in schools, in day care centers etc. For persons who need to wash their hands frequently skin care is also an important aspect.

The need remains to develop a wipe, especially for personal hygiene, such as in the urogenital area of wearers of absorbent articles, hand wiping, foot wiping etc., said wipe fulfilling one or more of the following properties: cleaning, skin care, odour control, antibacterial effect or the like. The wipe may also be used for cleaning surfaces where odour control and/or bacterial control is desired.

### SUMMARY OF THE INVENTION

The above defined problem is solved in the present invention by a wipe, containing a composition comprising at least one oxidized lipid having a peroxide value as measured by AOCS Official Method Cd 8-53 of at least 20 meq/kg. It has surprisingly been found that lipids with peroxide values of at least 20 meq/kg show a better odour-reducing ability than lipids with very low peroxide values.

Preferably the oxidized lipids have a peroxide value as measured by AOCS Official Method Cd 8-53 of at least 30 and preferably at least 40 meq/kg.

In a further aspect of the invention at least 0.01 g/g of the oxidized lipids has been added to said wipe, calculated on the total weight of the wipe.

In a still further aspect between 0.01 and 15 g/g, preferably between 0.1 and 8 g/g, more preferably between 0.2 and 4 g/g and most preferably between 0.3 and 3 g/g of the oxidized lipids has been added to the wipe, calculated on the total weight of the wipe.

According to one embodiment the lipids are fatty acids or derivatives thereof. The fatty acid derivatives are in a further embodiment esters of fatty acids, especially triglycerides.

According to a further embodiment at least part of said fatty acids and/or fatty acid derivatives are unsaturated.

In one embodiment said oxidized lipids are oxidized by treatment with ozone.

In one aspect of the invention the carrier material is chosen from: a fibrous web, a foam, a net or a film.

In a further aspect of the invention the wipe is a personal hygiene wipe such as a baby care, feminine hygiene care, incontinence care, hand care, foot care wipe or the like.

### DEFINITIONS

The term “wipe” denotes any device for wiping, and in particular intended to personal hygiene for wiping skin. The invention mainly refers to disposable wipes, which means wipes that are not intended to be laundered or otherwise restored or reused as an absorbent article after use. Examples of disposable wipes include washcloths, patches, towelettes, napkins, wet wipes, and the like.

The term “carrier material” denotes any material adapted as a wiping material. Suitable carrier materials are porous materials capable of holding the oxidized lipid in its structure and which also have capacity to absorb substances which should be removed from the skin. Examples of suitable porous materials are fibrous webs made of natural or synthetic fiber or combinations thereof. Examples of fibres include cellulose, regenerated cellulose (viscose, rayon, lyocell etc.), cotton, bamboo, polyester, polyolefin fibers and mixtures thereof. Other types of porous carrier materials in wipes are foams, nets etc.

The term “lipid” denotes all fat-soluble (lipophilic), naturally-occurring substances, such as fats, oils, waxes, cholesterol, steroids, monoglycerides, diglycerides, triglycerides, phospholipids, and others.

By “oxidized lipids” is meant that the lipids have undergone an oxidation process wherein oxygen has been introduced in the lipid molecular structure. The oxidation agent is any agent, which leads to oxidation of the lipid structure, e.g. oxygen gas, ozone or peroxides. The lipids are oxidized under controlled conditions which means that the substrate, i.e. the lipid has been oxidized to a degree wherein further oxidation caused by autoxidation from contact with air is substantially prevented. The lipids have been oxidized so that they have a peroxide value as measured by AOCS Official Method Cd 8-53 of at least 20 meq/kg.

### DETAILED DESCRIPTION OF THE INVENTION

It has according to the invention been shown that oxidized lipids, are very effective in reducing certain odoriferous substances which are commonly occurring in absorbent articles and in the urogenital area of wearers of such articles. Natural animal-derived or plant-derived lipids are very often mixtures of mono-, di- and triglycerides and free fatty acids. The lipids can be purified, hydrated, refined, modified and used individually or in different mixtures. Examples of suitable lipids which originate from animals can be found in bees waxes, emu oil, lactis lipida, lanolin, shark's liver oil, lard, whale oil, butter fat and tallow. Examples of suitable lipids which originate from plants can be found in apricot kernel oil, ground nut oil, avocado oil/wax, blackcurrant seed oil, borage seed oil, Brazil nut oil, castor oil, cocoa butter, coconut oil, maize oil, cotton seed oil, rose hip seed oil, evening primrose oil, grape seed oil, linseed oil, mango seed oil, rose oil, olive oil, orange wax, palm oil, ground nut oil, rice wax, sesame seed oil, shea butter, soybean oil, sunflower seed wax, peanut oil, sesame oil, safflower oil, tobaccoseed oil, poppyseed oil, teased oil, kapok oil, rice bran oil, sorghum oil, crambe oil, linseed oil, perilla oil, hempseed oil, tung oil, oiticica oil, palm kern oil, sweet almond oil and wheat germ oil. Further examples of lipids are waxy oils, which are esters of mono-alcohols, for example jojoba oil and phospholipids etc.

Triglycerides are commonly occurring in many natural fats and oils, such as rapeseed oil, olive oil, maize oil, sunflower oil, palm oil, coconut oil and butter, palm oil, cacao butter, theobroma oil etc. Most of the naturally occurring triglycerides contain a mixture of saturated and unsaturated fatty acids, while the proportion of saturated and unsaturated fatty acids varies between the different oils. This proportion is usually given as the quotient: unsaturated/saturated. The unsaturated fatty acids may either be monounsaturated or polyunsaturated. The most commonly occurring fatty acids in triglycerides are palmitic acid, a saturated fatty acid, oleic acid, a monounsaturated fatty acid, linoleic and linolenic acids, which are polyunsaturated fatty acids.

The composition of some common natural oils are given in Table 1 below, which is taken from Bailey's Industrial Oil and Fat products, vol. 1, editor: Daniel Swern, John Wiley & Sons Inc., New York, 1979.

TABLE 1

| | Saturated fatty acids | Unsaturated fatty acids |
|---|---|---|
| Vegetable oil | (weight-%) | (weight-%) |
| Olive oil | 9.3-18.8 | 81.1-89.0 |
| Sunflower oil | 8.7-14.2 | 85-91 |
| Rapeseed oil | 6.2-9.5 | 90.5-93.8 |
| Maize oil | 12-18 | 82-88 |
| Cocoa butter | 59.8 | 40.2 |

Such oils and fats normally contain antioxidants, either naturally occurring or added by a supplier, so that autoxidation caused by contact with air is substantially prevented or delayed.

The lipids used in the present invention are oxidized by an oxidizing agent. Examples of useful oxidizing agents are: ozone, peroxides, oxygen gas, peroxy acids and nitrogen dioxide. For lipids containing antioxidants more powerful oxidizing agents like ozone and peroxides are required, but for lipids without any significant amounts of antioxidants, oxygen or air, i.e. autoxidation under a sufficient time period, may be sufficient.

The reactivity of different lipids is dependant on the number of double bonds, i.e. the degree of unsaturation. Saturated lipids oxidize very slowly while lipids with a high degree of unsaturation oxidize more rapidly. The relative rates of autoxidation at a temperature of 100° C. of some fatty acids (not treated with antioxidants) are found in Table 2 below and are taken from the same reference as for Table 1.

TABLE 2

| | Chemical | Relative rate |
|---|---|---|
| Fatty acid | formula | of oxidation |
| Stearic acid | C₁₇H₃₅COOH | 0.6 |
| Oleic acid | C₁₇H₃₃COOH | 6 |
| Linoleic acid | C₁₇H₃₁COOH | 64 |
| Linolenic acid | C₁₇H₂₉COOH | 100 |

The oxidation should preferably be performed under controlled conditions, so that after the oxidation process autoxidation is substantially prevented. Preferably the oxidized lipids should have a peroxide value as measured by AOCS Official Method Cd 8-53 of at least 20, preferably at least 30 and more preferably at least 40 meq/kg.

The lipids may be oxidized by any suitable method and by any suitable oxidation agent, for example by ozone, mixtures of ozone/air or ozone/oxygen.

At the oxidation process a series of peroxidic products may be formed, such as hydroperoxides, ozonides, diperoxides, peroxides and polyperoxides. Certain by-products may also be formed, for example ketones and aldehydes, which are less desired. These by-products may be removed by washing the lipids with a solvent after the oxidation process. Alternatively volatile undesired substances may be removed by evaporation, for example under vacuum.

It has according to the invention been shown that fibres treated with oxidized lipids, especially ozonized triglycerides, have a significant ability to reduce the emission of undesired odour compounds that are frequently occurring in the urogenital area of persons wearing absorbent articles. Examples of such odour compounds are dimethyl sulfide (DMS), dimethyl disulfide (DMDS) and isovaleric aldehyde (IVA).

The amount of oxidized lipids added may vary dependant on the intended use. For example in personal hygiene higher amounts of the oxidised lipids may be used in the urogenital area, where it is an advantage that the lipids remain on the skin, than in hand wiping, where it may be desired that only small amounts of the lipids may remain.

The wipe can contain between 0.01 and 15 g/g, preferably between 0.1 and 8 g/g, more preferably between 0.2 and 4 g/g and most preferably between 0.3 and 3 g/g of added oxidized lipids calculated on the total weight of the wipe. The amounts may differ dependant on the intended use.

Upon use of the wipes the composition containing the oxidized lipids is preferably transferred and delivered to the skin thereby serving as a skin treatment agent, especially for odour control and/or bacteria control.

The oxidized lipids may be distributed evenly throughout the wipe. Alternatively, the oxidized lipids may be localized in specific areas of the wipe, especially on the surface thereof, so as to be easily released from the wipe and transferred to the skin The composition with which the wipes of the present invention is impregnated may, in addition to the oxidized lipids, contain one or more of the following components: a viscosity regulating agent, a carrier for the oxidized lipid or an agent for improving the adhesion of the composition to the skin. Examples of viscosity regulating agents include polyethylene glycol (PEG) and glycerol. Quaternary tensides may be used as agents for improving the adhesion to skin. Other components which may be contained in the composition are cleaning agents, skin care agents, antibacterial agents, fragrances etc

The presence of oxidized lipids in wipes may also inhibit the growth/activity of bacteria which in turn produce substances that are able to contribute to a bad smell. The inhibition of growth/activity of unwanted bacteria is also important for hygienic reasons, both in the urogenital area, but also in handwiping. Frequent handwiping occurs for example in restaurants, kitchens, in medical care premises, in schools, in day care centers, industry, workshops etc. Besides the odour and bacteria control effects, the oxidised lipids may also have a skin care effect.

Other odour control substances can also be added to the wipe, for example chitosan, starch-based odour control substances and esters. The esters can be selected from among cyclical esters or esters selected from among isomentyl acetate, isomentyl propionate, isomentyl isobutyrate, isomentyl crotonate and isomentyl butyrate. The lipids may either be oxidized before being added to the fibers or after addition. The ozone may then at the same time act as a bleaching agent for the pulp, in case pulp fibres are present in the wipe.

The carrier material used in the wipe should be chosen so that it can hold the oxidized lipids in its porous structure and release it to the skin when the wipe is used. It shall preferably also be capable to absorb substances that have been wiped off the skin. Examples of suitable carrier materials are fibrous materials such as tissue paper, airlaid tissue and different type of nonwoven materials. Examples of nonwoven materials are hydroentangled webs, spunbond, meltblown, thermobonded webs etc. Further examples of carrier materials are foams, nets, films etc. In the case of films the oxidised lipids may be applied between film layers and exposed when separating the film layers from each other and/or applied in formed recesses in the film.

The structure of the carrier material is important for its function to hold liquid substances. A material that is especially suitable in this respect is hydroentangled webs.

Fibres that are useful in fibrous carrier materials are pulp fibres, cotton fibres, bamboo fibres and other natural fibres, regenerated cellulose fibres such as viscose, lyocell, polyolefin fibres, like polyethylene and polypropylene, polyester and mixtures thereof.

For a so called wet wipe a suitable fiber composition may be a mixture of viscose fibers and polyester fibers, for example 70 wt % viscose fibers and 30 wt % polyester.

A common fiber composition in other type of wipes is a mixture of pulp fibers and polypropylene.

A suitable basis weight for a personal hygiene wipe is between 30 and 70 g/m², preferably between 40 and 50 g/m².

The size of the wipes may vary depending on its intended use and how dirty the surface to be cleaned is. Examples of suitable sizes are 10×15 cm, 12×20 cm and 16×18 cm.

The composition comprising the oxidized lipids may be added to the carrier material by spraying, coating and impregnation.

### EXAMPLES

### Ozonization of Oil/Fat

### Trial 1

The ozone was generated in an Argenotox ozone generator, type GL, Hamburg, operated at a voltage of 150V, an inlet oxygen flow of 63 l/h. 200 g of each tested oil/fat was treated during a time period of 2 h with an ozone/oxygen flow of 0.061 g/min. The ozone concentration of the added gas was 58 g/m³.

For the more strongly ozonized sunflower oil according to table 8, having a peroxide value of 276.9 meq./kg, ozone was bubbled through 50 g oil for 5.5 h.

The gas was bubbled through the oil which was contained in a vented vessel. A magnetic stirrer was used in the vessel. The solid fats were gently heated above melting temperature, after which the gas was bubbled through the liquid fats. The tested oils/fats are those stated in Table 3 below.

TABLE 3

| | | | | Quotient |
|---|---|---|---|---|
| | | Single | Multiple | unsaturated/ |
| | Saturated % | unsaturated % | unsaturated % | saturated |
| Sunflower | 11 | 28 | 56 | 7.64 |
| oil | | | | |
| Olive oil | 18 | 70 | 12 | 4.56 |
| Rapeseed | 7 | 62 | 31 | 13.29 |
| oil | | | | |
| Maize oil | 12 | 28 | 55 | 6.92 |
| Cacao | 61 | 36 | 3 | 0.64 |
| butter | | | | |

The degree of oxidation was tested by determining the peroxide value according to the test method AOCS Official Method Cd 8-53 Surplus 2003. The peroxide value for both the starting oils/fats and the ozonized oils/fats was determined. The results are given in Table 4 below.

TABLE 4

| Oil | Peroxide value (meq/kg) |
|---|---|
| Rapeseed oil | 3.82 |
| Ozonized rapeseed oil | 42.09 |
| Maize oil | 4.21 |
| Ozonized maize oil | 60.04 |
| Olive oil | 7.99 |
| Ozonized olive oil | 61.41 |
| Sunflower oil | 7.10 |
| Ozonized sunflower oil | 65.49 |
| Cacao butter | 3.32 |
| Ozonized cacao butter | 69.51 |

Treatment of Pulp with Oils/Fats

Sheets of sulfate pulp from Weyerhaeuser Inc., with the designation NB416, were impregnated with a solution of the tested oil/fat in hexane. To a pulp sheet weighing 10 g was added a solution of 4.29 g oil in 4.29 g hexane. The solution was evenly distributed over the surface of the sheets. When the hexane had evaporated the sheets contained 30% by weight oil/fat and 70% by weight pulp fibers. The treated sheets were defibrated in a Braun multimixer MX32 to produce fluff pulp.

### Analysis of Odour Reduction

1 g of treated pulp was put in a 60 ml vial, after which 3.9 ml of 0.01 M phosphate buffered saline solution pH 7.4 from Sigma was added. Then 0.1 ml PEG300 with DMS (dimethyl sulfide), DMDS (dimethyl disulfide) and IVA (isovaleric aldehyde) was added so that the concentration of each odour substance in the final solution was 1000 ng/ml.

After 3 h at 35° C. a SPME fiber (Supelco), 75 μm Carboxen-PDMS, was injected into the headspace above the pulp and after an additional 0.5 h the SPME fiber was analyzed with gas chromatography (GC), Thermo Finnigan Trace, with a MS detector. The peak area of each odour substance was determined for samples with treated pulp and the untreated reference pulp. The GC settings were:

Temperature program for GC: 30° C. (7 min), 3° C./min-70° C. (0 min), 40° C./min-250° C. (7 min).
Column: ZB-624 (Zebron), 30 m, 0.25 mm i.d. 1.40 μm film thickness
Inlet temperature: 250° C.
Transfer line: 220° C.

### Mode: Splitless

MS: SIM (single ion monitoring). When DMS, IVA and DMDS were analyzed the following mass numbers were detected: 45, 46, 47, 57, 58, 61, 62, 79, 86 and 94.

### Results of Odour Reduction

The tests showed that the ozonized oils/fats had a significantly higher reduction effect on the odour substances than the corresponding oils/fats that had not been ozonized. The odour reduction results are given in Table 5 below. The odour reduction was determined by comparing the peak area of the tested sample with the same peak area achieved when testing the untreated reference pulp. The calculation of the odour reduction in percent was made by the equation:

Odour reduction=100×(1−Actual peak area/Peak area of sample with untreated pulp) [1]

TABLE 5
Reduction of odour substances in %

| | DMS | IVA | DMDS |
|---|---|---|---|
| Sunflower oil | 0 | 0 | 31.6 |
| Ozonized sunflower oil | 99.9 | 96.7 | 99.1 |
| Cacao butter | 35.1 | 0 | 48.2 |
| Ozonized cacao butter | 79.8 | 50.0 | 59.1 |
| Rapeseed oil | 35.8 | 38.5 | 36.5 |
| Ozonized rapeseed oil | 99.4 | 96.2 | 91.2 |
| Maize oil | 87.1 | 66.0 | 88.4 |
| Ozonized maize oil | 99.9 | 96.4 | 99.6 |
| Olive oil | 84.0 | 69.2 | 73.0 |
| Ozonized olive oil | 99.9 | 97.7 | 95.9 |

### Ozonization of Further Lipids

### Trial 2

### Ethyl Linoleate

100 g ethyl linoleate, technical grade achieved from Alrich, was treated for 6 h with ozone generated with an Argentox ozone generator, type GL, Hamburg, operated at a voltage of 150V and an inlet oxygen flow of 63 l/h. The ozone addition was 0.061 g/min. and the ozone concentration of the added gas was 58 g/m³. After ozonization, the peroxide value was measured according to AOCS Official method Cd 8-53 and found to be 237.4 meqv./kg.

### Oleic Acid:

100 g oleic acid, technical grade from Fluka, was treated for 5 h with ozone generated with an Argentox ozone generator, type GL, Hamburg, operated at a voltage of 150V and an inlet oxygen flow of 63 l/h. The ozone addition was 0.061 g/min. and the ozone concentration of the added gas was 58 g/m³. After ozonization, the peroxide value was measured according to AOCS Official method Cd 8-53 and found to be 375.3 meqv./kg

### Jojoba Oil

100 g jojoba oil prepared from Simmondsia Chinensis and delivered by Fluka, was treated for 5 h with ozone generated with an Argentox ozone generator, type GL, Hamburg, operated at a voltage of 150V and an inlet oxygen flow of 63 l/h. The ozone addition was 0.061 g/min. and the ozone concentration of the added gas was 58 g/m³. After ozonization, the peroxide value was measured according to AOCS Official method Cd 8-53 and found to be 178.5 meqv./kg

### Asolectin

50 g powder of asolectin from soyabeens, achieved from Fluka, was suspended in 150 g distilled water. Asolectin is a mixture of different phospholipids. The suspension was treated for 2 h with ozone generated with an Argentox ozone generator, type GL, Hamburg, operated at a voltage of 150V and an inlet oxygen flow of 63 l/h. The ozone addition was 0.061 g/min. and the ozone concentration of the added gas was 58 g/m³. After ozonization, the material was cooled down to about −20° C. in a Tefcold freezer, type TFF370 and then freeze dried in an Edwards Modulyo freeze dryer. After freeze-drying a dry ozonated asolectin powder was collected and its peroxide value was measured to 382.2 meqv./kg according to AOCS Official method Cd 8-53.

These ozonized lipids were tested for their odour reducing effect on treated pulp in the same manner as under Trial 1 above. The only exception in the laboratory procedure was the method for treatment of the pulp with Acolectin. In this case the lipid was added as a dried powder to the already fluffed pulp. The following results were obtained.

TABLE 6
Reduction of odour substances in %

| | DMS | IVA | DMDS |
|---|---|---|---|
| Ethyl linoleate | 0 | 0 | 0 |
| Ozonized ethyl | 98 | 48.6 | 53.2 |
| linoleate | | | |
| Oleic acid | 67.5 | 9.3 | 19.2 |
| Ozonized oleic acid | 99.4 | 98.6 | 100 |
| Jojoba oil | 27.9 | 25.5 | 24.1 |
| Ozonized jojoba oil | 99.9 | 80.5 | 75.9 |
| Asolectin | 16 | 16 | 8 |
| Ozonized asolectin | 100 | 98.9 | 84.6 |

Tests with Different Amounts of Added Oils Having Different Peroxide Values

Tests were performed with treated pulp to which had been added different amounts of ozonized sunflower oil, 0, 3, 10 and 30% by weight respectively. Two different ozonized sunflower oils were used, one having a peroxide value of 65.6 meq./kg and the other a peroxide value of 276.9 meq/kg.

The pulp was treated in the following manner:

A sheet of bleached kraft pulp with the trade name NB416 produced by the Weyerhaeuser Company was treated with oil dissolved in a suitable evaporable solvent. The solution was poured onto 10 g of the sheet, which absorbed the liquid and distributed the oil well in the fibre network. The solvent was then evaporated by simply keeping the sheets at room temperature for at least 3 h. The following solutions were prepared:
a. 0.31 g ozonized sunflower oil with a peroxide value of 65.5 dissolved in 8.27 g hexane. This addition means that the pulp sheet will contain 3% oil.
b. 1.11 g ozonized sunflower oil with a peroxide value of 65.5 dissolved in 7.47 g hexane. This addition means that the pulp sheet will contain 10% oil.
c. 4.29 g ozonized sunflower oil with a peroxide value of 65.5 dissolved in 4.29 g hexane. This addition means that the pulp sheet will contain 30% oil.
d. 0.31 g ozonized sunflower oil with a peroxide value of 276.9 dissolved in 8.27 g acetone. This addition means that the pulp sheet will contain 3% oil.
e. 1.11 g ozonized sunflower oil with a peroxide value of 276.9 dissolved in 7.47 g acetone. This addition means that the pulp sheet will contain 10% oil.
f. 4.29 g ozonized sunflower oil with a peroxide value of 276.9 dissolved in 4.29 g acetone. This addition means that the pulp sheet will contain 30% oil.

After evaporation of the solvent, the oil-impregnated sheets were torn into pieces and dry defibrated in a Braun multimixer MX32. The defibrillation was performed at maximum intensity until a fairly homogeneous fluffed pulp was formed.

For comparison, a sheet of untreated bleached kraft pulp (NB416) was defibrated in the same way.

Used chemicals:
Sunflower oil: Food grade oil delivered by a local provision-shop (COOP)
Hexane: Pro Analysi, from Merck
Acetone: Puriss, delivered by Fluka

The tests were then performed in the same manner as described above. The results from these tests are shown in Table 7 and 8 below.

TABLE 7
Reduction of odour substances in % by the addition of ozonized
sunflower oil having a peroxide value of 65.5 meq./kg

| Addition of ozonized | | | |
|---|---|---|---|
| sunflower oil (wt %), | DMS | DMDS | IVA |
| 0 | 0 | 0 | 0 |
| 3 | 50.4 | 21.7 | 0 |
| 10 | 95.8 | 73.3 | 73.3 |
| 30 | 98.7 | 93.5 | 86.7 |

TABLE 8
Reduction of odour substances in % by the addition of ozonized
sunflower oil having a peroxide value of 276.9 meq./kg

| Addition of ozonized | | | |
|---|---|---|---|
| sunflower oil (wt %), | DMS | DMDS | IVA |
| 0 | 0 | 0 | 0 |
| 3 | 94.6 | 55.6 | 92.8 |
| 10 | 100.0 | 95.2 | 92.9 |
| 30 | 100.0 | 100.0 | 96.0 |

These result show that such a low addition as 3 weight % of ozonized sunflower oil can give a strong reduction of the added odour substances and that the oil having the higher peroxide value gives a stronger odour reduction. It can be mentioned that ozonized sunflower oils having peroxide values above 1000 meq./kg are known in literature. Therefore it can be assumed that an addition of much less than 3 weight % of an oil having a high peroxide value can give an acceptable odour inhibition.

### Practical Odour Test

A practical sensory odour test was also performed in which the test persons smelled at the samples from the above measurements after the GC tests. The test persons opened the vials and smelled at the pulp samples with added odour substances. The following results were obtained:

| Sample | Smell |
|---|---|
| Reference: untreated pulp | Very strong, |
| | unpleasant odour |
| 3% ozonized sunflower oil, peroxide value 65.5 | Clear odour, |
| | reduced compared |
| | to the reference. |
| 10% ozonized sunflower oil, peroxide value 65.5 | Weak odour |
| 30% ozonized sunflower oil, peroxide value 65.5 | No unpleasant odour |
| 3% ozonized sunflower oil, peroxide value 276.9 | Weak odour |
| 10% ozonized sunflower oil, peroxide value 276.9 | No unpleasant odour |
| 30% ozonized sunflower oil, peroxide value 276.9 | No unpleasant odour |

Treatment of Wipes with Lipids

A spunlaced nonwoven with the trade name Fibrella 7160, available from Suominen (Finland) was used in these experiments. This material, which consists of about 60% polypropylene fibres and 40% rayon fibres, has a basis weight of about 50 g/m². Pieces with a weight of 1 g and an area of 0.020 m² were cut from the spunlaced nonwoven sheet. These pieces were then treated with lipids. 2 g of the lipid was dissolved in 4 g of either hexane or acetone and evenly distributed on the piece of nonwoven. Acetone was used to dissolve all ozonated oils and oleic acid while the other not ozonated oils where dissolved in hexane. After several hours, when the solvent had evaporated, the nonwoven pieces were folded and inserted into 60 ml vials, used for SPME analysis. The vials were then flushed with nitrogen gas and sealed. The lipids used for treatment of wipes are listed in Table 9.

TABLE 9
Lipids used for treatment of wipes

| Lipid | Peroxide value (meqv./kg) |
|---|---|
| Sunflower oil | 7.1 |
| Ozonized sunflower oil | 276.9 |
| Maize oil | 4.2 |
| Ozonized maize oil | 60.0 |
| Olive oil | 8.0 |
| Ozonized olive oil | 61.4 |
| Oleic acid | 3.1 |
| Ozonized oleic acid | 375.3 |

### Analysis of Odour Reduction of Wipes

Vials with a volume of 60 ml containing 1 g spunlaced nonwoven treated with 2 g lipid were used in these tests. The laboratory procedure was the same as earlier described when evaluating the odour reduction of fluffed pulp, see page 10-11. To each vial was added 3.9 ml phosphate buffered saline solution, pH 7.4 and 0.1 ml PEG300 with DMS, DMDS and IVA. The total concentration of each odour compound was 1000 ng/ml.

TABLE 10
Reduction of odour substances in %

| | DMS | IVA | DMDS |
|---|---|---|---|
| Sunflower oil | 66.4 | 79.1 | 89.8 |
| Ozonized sunflower oil | 99.99 | 95.5 | 99.97 |
| Maize oil | 87.3 | 92.1 | 97.0 |
| Ozonized maize oil | 100 | 99.3 | 99.1 |
| Oleic acid | 67.4 | 74.5 | 83.6 |
| Ozonized oleic acid | 100 | 100 | 100 |
| Olive oil | 69.5 | 91.1 | 94.5 |
| Ozonized olive oil | 99.5 | 96.3 | 96.3 |

### Bacterial Growth Measurements

Test liquid 1 was used for bacterial growth measurements: Sterile, synthetic urine to which a growth medium for microorganisms had been added. The synthetic urine contained monovalent and divalent cations and anions and urea and had been produced in accordance with the information in Geigy, Scientific Tables, vol. 2, 8th ed., 1981, page 53. The growth medium for the microorganisms is based on two common growth media, Hook and FSA medium for enterobacteria. The pH in this mixture was 6.6.

A homogenous mixture of fluffed pulp was prepared in the following way (Method 1) Untreated and treated Weyerhaeuser pulp (NB416) was weighed in desired proportions and put in Braun multimixer, MX32. The pulp was mixed about 30 seconds.

Absorbent cores for testing were produced in the following way (Method 2): Absorbent cores were prepared using a slightly modified sample former according to SCAN C 33:80. Fluffed pulp of the desired type(s) was weighed and a homogeneous mixture of the fluffed pulp(s) was introduced into a flow of air having a negative pressure of approximately 75 mbar, through a pipe having a diameter of 10 mm and being equipped at the bottom with a metal net. The fluff pulp was gathered on the metal net and thereafter constituted the absorbent specimen. The absorbent core was compressed to a bulk within the range of 6 to 12 cm³/g.

Two different absorbent cores were produced; the reference core composed of 2.0 g untreated Weyerhaeuser pulp (NB 416) and the test core composed of a mixture of 1.4 g treated Weyerhaeuser pulp (NB 416), treated with oxidized sunflower oil, peroxide value 65.5 meq./kg, according to the method described under “Treatment of pulp with oils/fats” above (added amount was 30 weight % oil), and 1.0 g of untreated Weyerhaeuser pulp (NB 416). The size of the absorbent cores was 5 cm in diameter.

The bacterial growth in the absorbent cores was measured in the following way (Method 3):

10 ml of test liquid 1 containing bacteria were added to a test core placed in a sterile jar (Nunc sputum/organ jars, 100 ml), and a lid was fitted on the jar. The jar was turned upside down and incubated in a warm cabinet at 35° C. After incubation for 0, 6 and 12 hours, the test cores were placed in a plastic bag with peptone water and the content was homogenized (agitated and worked up) in a stomacker for 3 minutes. The homogenate was diluted in dilution tubes with peptone water and a microbiological culture was spread on agar plates. Slanetz Bartley agar was used for E. faecalis, and Drigalski agar for E. coli and P. mirabilis. The specimens were incubated at 35° C. for 1-2 days before the colonies were counted and the log CFU/ml calculated (CFU=counted number of colony forming units). Control tests were also carried out with reference cores

### Test Results: Bacterial Growth

Bacteria were cultured in nutrient broth and diluted to the desired concentration which had a logarithmic value of 3.3 in test liquid 1 (method 3). Absorbent test cores were produced according to method 2. The bacterial growth was measured according to method 3.

The result is shown in Table 11, which clearly illustrates that the growth of all 3 test bacteria is considerably lower after 6 and 12 hours in the test cores, compared with the reference core. The table shows log CFU/ml after different periods of time. Test sample means pulp containing ozonized sunflower oil and reference sample means the untreated pulp.

TABLE 11

| | 0 h | | | 6 h | | | 12 h | | | pH | | |
|---|---|---|---|---|---|---|---|---|---|---|---|---|
| Sample | E. coli | P. mir. | E. faec. | E. coli | P. mir. | E. faec. | E. coli | P. mir. | E. faec. | 0 h | 6 h | 12 h |
| Test 1 | 3.5 | 3.2 | 3.2 | <2 | <2 | <2 | <2 | <2 | <2 | 6.2 | 5.9 | 5.6 |
| Test 2 | 3.4 | 3.2 | 3.3 | <2 | <2 | <2 | <2 | <2 | <2 | 6.3 | 5.9 | 5.6 |
| Test | 3.5 | 3.2 | 3.3 | <2 | <2 | <2 | <2 | <2 | <2 | 6.2 | 5.9 | 5.6 |
| mv | | | | | | | | | | | | |
| Ref. 1 | 3.5 | 3.2 | 3.2 | 6.1 | 5.0 | 6.3 | 9.7 | 8.8 | 9.1 | 6.6 | 6.6 | 8.9 |
| Ref. 2 | 3.4 | 3.2 | 3.3 | 6.5 | 5.1 | 6.2 | 8.8 | 7.8 | 8.1 | 6.6 | 6.6 | 8.6 |
| Ref. | 3.5 | 3.2 | 3.3 | 6.3 | 5.0 | 6.3 | 9.5 | 8.5 | 8.8 | 6.6 | 6.6 | 8.7 |
| mv | | | | | | | | | | | | |

Candida albicans Growth Measurements

Corresponding tests as above have been performed to test the effect on growth of Candida albicans. A Test liquid 1 as described above was prepared for the growth measurements. Fluffed pulp was prepared according to Method 1 and absorbent cores were prepared according to Method 2. However the oxidised oil was in this case oxidised sunflower oil having a peroxide value of 276.9 mmol/kg according to the method described under “Treatment of pulp with oils/fats” with the exception that acetone was used to dissolve the ozonized sunflower oil instead of hexane.

C. albicans was cultured in Todd Hewitt broth to stationary phase and diluted to the desired concentration of about 10⁴ CFU/ml in test liquid 1.

10 ml of Test liquid 1 containing C. albicans was added to the test core respective the reference core, which were placed in sterile plastic jars, and the jars were covered with aluminum foil. The jars were incubated in a warm cabinet at 37° C. After incubation for 0, 4, 6 and 8 hours, the test and reference cores were placed in a plastic bag with 20 ml saline solution and the content was homogenized (agitated and worked up) in a stomacher for 3 minutes (high speed). The homogenate was diluted in dilution tubes with saline solution and the suspension was spread on Sabaroud-dextrose agar plates. The plates were incubated at 37° C. 2 days before the colonies were counted and the log CFU/ml calculated.

The results are shown in Table 12 below, which are mean values from two test samples. The table shows log CFU/ml after different periods of time. Test sample means pulp containing ozonized sunflower oil and reference sample means the untreated pulp.

TABLE 12
Candida albicans

| Sample | 0 h | 4 h | 6 h | 8 h |
|---|---|---|---|---|
| Ref. | 4.83 | 5.60 | 6.06 | 6.64 |
| Test | 4.41 | 0 | 0 | 0 |

As can be seen from the table the growth of C. albicans was strongly inhibited in the test cores and was already after 4 hours zero.

### Examples of Wipes

### Example 1

### Wipe for Uro-Genital Care

100 g olive oil (extra virgin olive oil, COOP) was ozonized according to trial 1 to the peroxide value of 61.41 meq/kg. The ozonized olive oil was washed by extraction with ethanol. The extraction was made by mixing 100 g ozonized olive oil and 160 g ethanol in a beaker under vigorous stirring. The mixture was then centrifuged in order to achieve two distinct phases. The ethanol phase was removed and the ozonized olive oil was further extracted 4 times according to the same procedure. The total amount of ethanol was 5×160 g=800 g. After the last extraction, the ozonized olive oil was treated at 60° C. in a rotary evaporator for 3 h to remove traces of ethanol.

Tissue sheet (Fibrella 7160, 60% PP/40% Viscous, 50 g/m2, from Suominen) with a size of 16×18 cm were sprayed with ozonized and extracted olive oil to a final concentration of 1.5 g/g dry tissue.

### Example 2

### Wipe for Hand Cleaning

50 g sun flower oil (COOP) was ozonized according to trial 1 to the peroxide value of 276.9 meq/kg. The ozonized sun flower oil was washed by extraction with ethanol. The extraction was made by mixing 50 g ozonized olive oil and 80 g ethanol in a beaker under vigorous stirring. The mixture was then centrifuged in order to achieve two distinct phases. The ethanol phase was removed and the ozonized olive oil was further extracted 4 times according to the same procedure. The total amount of ethanol was 5×80 g=400 g. After the last extraction, the ozonized olive oil was treated at 60° C. in a rotary evaporator for 3 h to remove traces of ethanol.

Tissue sheet (SCA, Tork Premium multipurpose cloth 520, 70 g/m2) with a size of 24×24 cm were sprayed with the ozonized and extracted sun flower oil to a final concentration of 3 g/g dry tissue.

1. A wipe comprising a carrier material to which a composition having one or more of cleaning, skin care, odour control, or antibacterial effect, has been added, wherein said composition comprises at least one oxidized lipid having a peroxide value as measured by AOCS Official Method Cd 8-53 of at least 20 meq/kg.

2. The wipe as claimed in claim 1, wherein the oxidized lipids have a peroxide value as measured by AOCS Official Method Cd 8-53 of at least 30 meq/kg.

3. The wipe as claimed in claim 1, wherein to said wipe has been added at least 0.01 g/g of the oxidized lipids, calculated on the total weight of the wipe.

4. The wipe as claimed in claim 3, wherein to said wipe has been added between 0.01 and 15 g/g of the oxidized lipids, calculated on the total weight of the wipe.

5. The wipe as claimed in claim 1, wherein the lipids are fatty acids or derivatives thereof.

6. The wipe as claimed in claim 5, wherein the fatty acid derivatives are esters of fatty acids.

7. The wipe as claimed in claim 5, wherein at least part of the fatty acids and/or fatty acid derivatives are unsaturated.

8. The wipe as claimed in claim 1, wherein said oxidized lipids are oxidized by treatment with ozone.

9. The wipe as claimed in claim 1, wherein the carrier material is selected from the group consisting of a fibrous web, a foam, a net and a film.

10. The wipe as claimed in claim 1, wherein the wipe is a personal hygiene wipe selected from the group consisting of baby care, feminine hygiene care, incontinence care, hand care, and foot care wipes.

11. The wipe as claimed in claim 2, wherein the oxidized lipids have a peroxide value as measured by AOCS Official Method Cd 8-53 of at least 40 meq/kg.

12. The wipe as claimed in claim 4, wherein to said wipe has been added between 0.1 and 8 g/g of the oxidized lipids, calculated on the total weight of the wipe.

13. The wipe as claimed in claim 4, wherein to said wipe has been added between 0.2 and 4 g/g of the oxidized lipids, calculated on the total weight of the wipe.

14. The wipe as claimed in claim 4, wherein to said wipe has been added between 0.3 and 3 g/g of the oxidized lipids, calculated on the total weight of the wipe.

15. The wipe as claimed in claim 6, wherein the esters of fatty acids are triglycerides.
